(19) United States
(12) Patent Application Publication
(10) Pub. No.: US 2023/0153461 A1
(43) Pub. Date: May 18, 2023

(54) SHARED MODEL TRAINING WITH PRIVACY PROTECTIONS

(71) Applicants: Hamid R. Tizhoosh, Rochester, MN (US); THE TORONTO-DOMINION BANK, TORONTO (CA)

(72) Inventors: Shivam Kalra, Waterloo (CA); Jesse Cole Cresswell, Toronto (CA); Junfeng Wen, Waterloo (CA); Maksims Volkovs, TORONTO (CA); Hamid R. Tizhoosh, Rochester, MN (US)

(21) Appl. No.: 17/987,761

(22) Filed: Nov. 15, 2022

Related U.S. Application Data
(60) Provisional application No. 63/279,929, filed on Nov. 16, 2021.

(51) Int. Cl. G06F 21/62

(52) U.S. Cl. CPC G06F 21/6245

(57) ABSTRACT

A model training system protects data leakage of private data in a federated learning environment by training a private model in conjunction with a proxy model. The proxy model is trained with protections for the private data and may be shared with other participants. Proxy models from other participants are used to train the private model, enabling the private model to benefit from parameters based on other models’ private data without privacy leakage. The proxy model may be trained with a differentially private algorithm that quantifies a privacy cost for the proxy model, enabling a participant to measure the potential exposure of private data and drop out. Iterations may include training the proxy and private models and then mixing the proxy models with other participants. The mixing may include updating and applying a bias to account for the weights of other participants in the received proxy models.

### CROSS-REFERENCE TO RELATED APPLICATION

This application claims the benefit of provisional U.S. Application No. 63/279,929, filed Nov. 16, 2021, the contents of which is incorporated herein by reference in their entirety.

### BACKGROUND

This disclosure relates generally to training computer models with model parameter sharing between devices, and more particularly to reducing exposure of private data during model training that includes sharing parameters.

Access to large-scale datasets is a primary driver of advancement in machine learning, with large datasets in computer vision or in natural language processing leading to remarkable achievements. In other domains, such as healthcare or finance, assembling or applying such large data sets faces restrictions on sharing data between entities due to regulations and privacy concerns. As a result, it may be impossible for institutions in many domains to pool and disseminate their data, which may limit the progress of research and model development. The ability to share information between institutions while respecting the data privacy of individual data instances (which may relate to specific individual persons) would lead to more robust and accurate models. Beyond the privacy of individual data instances that may be used for training, the data itself may be difficult to effectively share; in some medical imaging modalities, for example, an individual data instance may be a gigabyte or more, such that simply transferring and managing a large pool of such data across institutions may present its own difficulties that would benefit from local model training.

As an alternative, some solutions have instead proposed sharing model parameters between institutions, such that individual training data is not shared across institutions. However, even sharing model parameters may leak information about the underlying data composition, and, in some circumstances, about individual data instances. For example, sharing gradients for modifying model parameters can risk revealing distributions of the underlying training data. Further, as complex deep computer models may be capable of overfitting data instances (in effect, “memorizing” the output for a specific data instance), shared parameters may reveal information about these individual instances. Finally, sophisticated models may include a very large number of parameters, such that sharing parameters or consolidating information from different models should be efficient and it may be beneficial not to rely on a central system to consolidate model parameter updates. For example, while one approach (i.e., “federated learning”) consolidates model parameter updates (e.g., training gradients) centrally to address data that could not be effectively centralized, this solution may not be suited to the multi-institutional collaboration problem, as it involves a centralized third party that controls a single model. In addition, for complex models having a high number of parameters (e.g., 1 M+), communicating gradients and updated models to and from the centralized system may impose significant bandwidth requirements on the centralized system as it receives and sends updates from all participants. In a collaboration between participants with highly sensitive data, such as medical providers, this federated approach may also be undesirable as each hospital may seek autonomy over its own model for regulatory compliance and tailoring to its own specialty.

As such, improvements are needed for effective cross-participant model training that allows participants to share models efficiently while also limiting or preventing private data leakage and maintaining high model accuracy with respect to each participants’ private data.

### SUMMARY

To provide privacy controls while permitting the benefits that may accrue with a larger data pool, each participant (e.g., an entity, such as a hospital) may use its own private training data to update parameters of a proxy model, which may be shared with other participants, and a private model, which is not shared. The training process may include multiple iterations in which the models are trained locally at each participant and the proxy models are mixed among the participants.

In the training step, the proxy model is jointly trained with the private model, such that the parameters of each model may be trained with a batch of training data. In addition to training with respect to a training batch, the models may also be trained with an objective (e.g., a training loss to be minimized) based on the other model’s predictions. That is, proxy parameters of the proxy model may be trained based on the training batch as well as the predictions of the private model; likewise, private parameters of the private model may be trained based on the training batch as well as on the predictions of the proxy model. This may provide for a training loss based on accuracy of the model with respect to the data (a predictive loss) and a difference with respect to predictions of the other model (a distillation loss). In addition, to mask data relating to individual training data, the proxy model may be trained with a differentially private algorithm (such as differentially private stochastic gradient descent) that may mask or obscure the effect of individual data instances on model parameter updates, which may permit a privacy cost to be calculated that measures the extent to which information about the participant’s private data could be revealed. As the models are trained, the participants may use the privacy cost to stop training its model or further sharing proxy models when the measured privacy cost exceeds its acceptable threshold, enabling the participants to have further control over the extent to which private data could be revealed.

In the mixing step, the proxy models may be shared with other participants’ proxy models (that were trained based on the respective participants’ unshared private training data and may be trained with a differentially private algorithm) and received proxy parameters are used to update a given participant’s model. The models may be mixed according to various schemes. While in one embodiment, the proxy models (i.e., the parameters or gradient updates thereof) may be shared with a system that consolidates models from multiple participants, in other embodiments, the proxy model parameters may be shared with peers and consolidated at each participant based on the received proxy model parameters. The proxy models may be shared (e.g., sent and received) based on an adjacency matrix describing which participants share with which other participants.

In one embodiment, participants also maintain a bias matrix that may be updated and applied at each mixing step to debias the proxy models according to a bias that may otherwise accumulate when the parameters are combined. The adjacency matrix may change at each training iteration, for example, to implement different combinations of participants to send and receive proxy models from one another. The adjacency matrix may be changed at each iteration according to various approaches, including an exponential communication protocol, such that the proxy model parameters are mixed with different participants and parameter contributions from one participant may be “passed” to distant participants through other participants. In one embodiment, the received proxy models in a given training iteration are combined and replace the prior proxy model (i.e., a particular participant’s proxy model parameters are replaced with parameters based on the received proxy model parameters), such that the proxy model at the beginning of a training step represents information gathered from other participants, and the proxy model after training (but before mixing) includes a contribution from that participant’s private data.

As the proxy model may thus represent information from other participants, the private model (jointly trained with the proxy model) may learn to account for signals from other participants through the proxy model at each training iteration, while accuracy with respect to the private data is directly learned by the private model through the loss related to the private data. During inference, the private model may then be used for predictions of new data for the participant. In addition, the private model, as it does not directly use the parameters of the proxy model (e.g., instead using a distillation loss related to predictions of the proxy model), may be configured with a different model architecture (such as a more complex architecture) than the proxy model (and which may also be different from other participants’ private models). A simpler proxy model may also reduce the privacy cost of training the proxy model. As such, these approaches permit the private model to gain a benefit from shared data of other participants with different private data while also measurably limiting the sharing of private data, and the model mixing approach permits effective peer-to-peer proxy model data sharing that permits individual participant dropout (e.g., when a participant’s privacy cost threshold has been reached) without requiring a central system to consolidate proxy model updates.

Finally, experiments on popular image datasets and a pan-cancer diagnostic problem using over 30,000 high-quality gigapixel histology whole slide images, show that an embodiment (designated “ProxyFL”) can outperform existing alternatives with less communication overhead and stronger privacy.

### BRIEF DESCRIPTION OF THE DRAWINGS

FIG. 1 shows an environment in which model training systems may share information about proxy models while maintaining the privacy of private data, according to one embodiment.

FIG. 2 illustrates a high-level overview of the training and inference of models according to one embodiment.

FIG. 3 shows an example of a training iteration for training parameters of a participant’s private model and proxy model, according to one embodiment.

FIGS. 4A-C show an exponential communication protocol, according to one embodiment.

FIGS. 5A-C shows the performance on the test datasets of one embodiment.

FIG. 6 shows the communication time for exchanging parameters for one embodiment in experiments.

FIG. 7 shows the performance of experiments with an embodiment on data with different levels of non-IID dataset skew.

FIGS. 8A-D show example results for an experiment, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

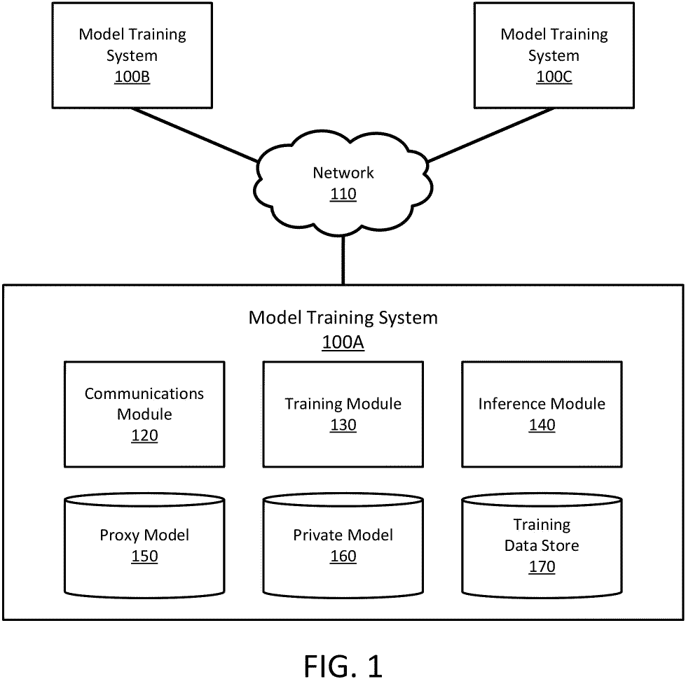

FIG. 1 shows an environment in which model training systems 100A-C may share information about proxy models while maintaining the privacy of private data, according to one embodiment. For simplicity of discussion, components are shown in FIG. 1 for model training system 100A; each other model training system such as model training system 100B, 100C may each have similar components. Each model training system 100A-C may represent an individual participant or entity that maintains a set of private data, at least a portion of which may be used as training data in the training data store 170. The private data may be sensitive, confidential, or other types of data that cannot be shared with other participants, such as medical, financial, or other types of data. Sharing information derived from the private data, such as model parameters, may also risk revealing information about the underlying private data.

To enable the model training systems 100A-C to effectively train models that take advantage of data from other participants (and for others to benefit from each participants’ private data), the model training system 100 trains parameters of a proxy model 150 and a private model 160 that may learn from the participant’s private data and from the parameters of the other model. For example, the proxy model 150 may be trained based on predictions of the private model 160 and the private model 160 may be trained based on predictions of the proxy model 150. During training, the proxy model 150 for each participant may then be shared with other model training systems. As further discussed below, the proxy model 150 may be a relatively simpler model than the private model 160 and may be trained with a differentially private algorithm that may quantify the extent to which private information could be derived from the proxy model parameters. Each of these may reduce the extent to which private data is revealed by sharing the proxy model. For convenience herein, “sharing” the proxy model may also refer to sharing of the parameters of the proxy model (e.g., specific weights or values for layers of the computer model) and may also refer to sharing training gradients of the model.

The proxy model 150 and private model 160 are machine-learned models that may have a number of layers for processing an input to generate predicted outputs. The particular architecture of the models may vary in different embodiments and according to the type of data input and output by the models. The input data may include high-dimensional images or three-dimensional imaging data, such as in various medical contexts and imaging modalities, and may include high-dimensional feature vectors of sequenced data (e.g., time-series data), such as in certain financial applications. The input data may include one or more different types of data that may be combined for input to the model or the model may include branches that independently process the input data before additional layers combine characteristics from the branches. As such, the proxy model 150 and private model 160 may have various types of architectures and thus include various types of layers having configurable parameters according to the particular application of the models. In many instances, the parameters represent weights for combining inputs to a particular layer of the model to determine an output of the model. Modifying the weights may thus modify how the model processes the respective inputs for a layer to its outputs. As examples of types of layers, the models may include fully-connected layers, convolutional layers, pooling layers, activation layers, and so forth.

A particular input example may be referred to as a data instance or data record, which may represent a “set” of input data that may be input to a model for which the model generates one or more output predictions. The output predictions may also vary in different embodiments according to the particular implementation and input data type. For example, in a medical context, one data item may include a radiological image along with a time-sequenced patient history. The output predictions may be a classification or rating of the patient as a whole with respect to a medical outcome, such as overall mortality risk or risk of a particular medical outcome, or may be a classification of regions of the image with respect to potential abnormalities, for example, outputting regions identified as having an elevated likelihood of an event for further radiologist review, or in some cases specifically classifying a likelihood of a particular abnormality or risk. In these examples, the training data in the training data store 170 may include input data instances along with labeled outputs for the data for which the models may be trained to learn parameters that accurately predict outputs matching the labels for a given input data instance.

The training module 130 trains parameters of the proxy model 150 and private model 160 based on the data in the training data store 170 and parameters of the models. In general, the models may be trained in one or more training iterations based on batches of training data from the training data store 170. Each training data instance may be processed by the current parameters of the respective models to determine a prediction from that model. The prediction by the model may be compared with the output labels associated with the training data instance to determine a predictive loss based on a difference of the model prediction with the desired prediction (i.e., the labeled outcome). In addition, and as further discussed below, a training loss may also be calculated with respect to the predictions of the other model, such that the proxy model 150 may be trained with a distillation loss based on the predictions of the private model 160, and the private model 160 may be trained with a distillation loss based on the predictions of the proxy model 150.

The communications module 120 may send and receive parameters of the proxy model 150 to other model training systems via a network 110 for mixing the parameters of the proxy model 150 at model training system 100 (e.g., corresponding to one participant), with the proxy models of other model training systems 100. For example, at one iteration of the training process, the model training system 100A may send parameters of its proxy model 150 to the model training system 100B and receive parameters of a proxy model from model training system 100C. The communications module 120 may send and receive proxy model parameters in coordination with the training module 130, and in one embodiment the training process may alternate between training the private model 160 and proxy model 150 and mixing the proxy model 150 with other participants’ proxy models (trained, in part, on other private data). Processes for training the models and mixing parameters of the proxy model 150 with other model training systems 100 are further discussed below.

After training, the models may then be used to predict outcomes for new data instances (i.e., instances that were not part of the training data set). In general, after training the private model 160 may be used for subsequent predictions. The inference module 140 may receive such new data instances and apply the private model 160 to predict outcomes for the data instance. Typically, the participant operating each model training system 100 may apply its private model 160 to data instances received by that participant, for example a medical practice may apply its private model 160 to new patients of that medical practice. Though shown as a part of the model training system 100A, the inference module 140 and application of the private model 160 to generate predictions of new data may be implemented in various configurations in different embodiments. For example, in some embodiments the inference module 140 may receive data from another computing system, apply the private model 160, and provide predictions in response. In other examples, the private model 160 may be distributed to various systems (e.g., operated by the participant) for application to data instances locally.

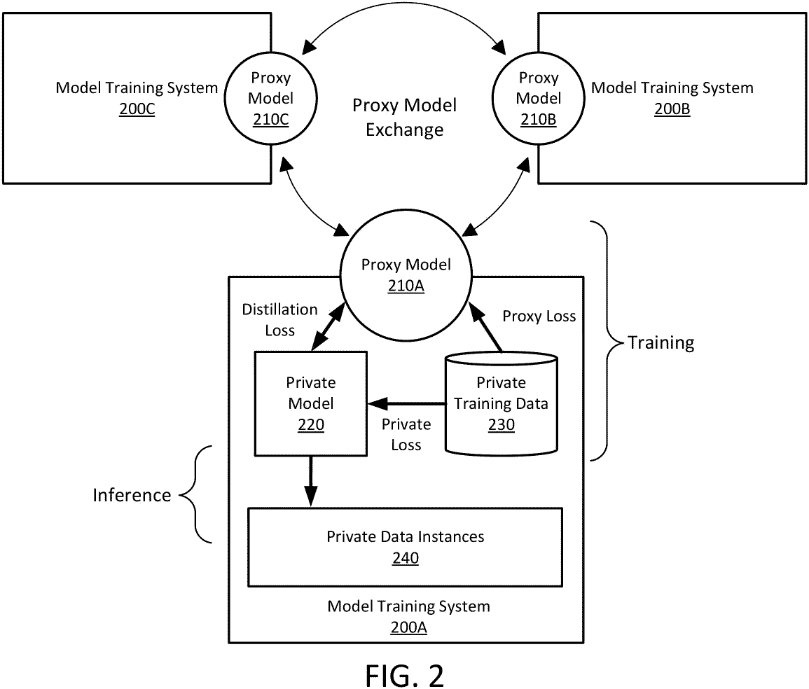

FIG. 2 illustrates a high-level overview of the training and inference of models according to one embodiment. In the example shown in FIGS. 1 and 2, three model training systems are shown, which may correspond to three participants. In additional embodiments, fewer or additional systems may interact for model training. As discussed above, a particular model training system, such as model training system 200A, may train a private model 220 as well as a proxy model 210A based on private training data 230. In one embodiment, the private model 220 and the proxy model 210A are trained with respect to a batch of training data from the private training data 230.

The training process for the proxy model 210A and private model 220 may vary in different embodiments. Generally, the proxy model may learn, based on the private model 220 and/or the private training data 230, such that sharing parameters of the proxy model 210A with other participants limits exposure of the private training data 230. In one embodiment, the proxy model 210 is trained based on a proxy loss relative to the private training data 230 for a batch and a distillation loss relative to the private model 220. The private model 220 may then be trained with a private loss relative to the private training data 230 and a distillation loss relative to the proxy model 210A.

In further detail, a batch of training data may be selected, and the current proxy parameters of the proxy model 210A and private parameters of the private model 220 are applied with the respective models to determine the respective predictions of the proxy model and the private model 220 with respect to the batch. In general, the proxy loss and private loss may evaluate the model predictions with respect to the labels of the private training data and calculate a loss based on a difference between the model predictions and the training data labels. In addition, the distillation loss may be used to evaluate the model predictions with respect to one another. As such, the proxy model 210A may have a distillation loss describing a difference between the proxy model predictions and the private model predictions for training data items, and the private model 220 may have a distillation loss describing a difference between the private model predictions and the proxy model predictions.

In one embodiment, the private loss may be a cross-entropy loss with respect to the label predictions, and the distillation loss may be a KL-divergence with respect to the proxy model predictions. Formally, Equation 1 shows one embodiment of the private loss using a cross-entropy (CE) loss L_{CE} for the application of private model ƒ with model parameters Φₖ corresponding to participant k (of K total participants) of participant k model parameters:

$${L}_{\text{CE}} \left({f}_{{ϕ}_{k}}\right) = {E}_{\left(x , y\right) ∼ {D}_{k}} \text{CE} \left[{f}_{{ϕ}_{k}} \left(x\right) \left‖y\right)\right]$$

in which x is training data input, y is a label, and E̅_{(x,y)~D}ₖ̅ is an expectation over the training data instances and labels for the batch ∼Dₖ selected from a participant’s private data set Dₖ.

In one embodiment in which the distillation loss for the private model 220 is a KL-divergence loss L_{KL} with respect to proxy parameters h_{θ}ₖ̅ of the proxy model 210A, the distillation loss L_{KL} may be described by Equation 2:

$${L}_{\text{KL}} \left({f}_{{ϕ}_{k}} ; {h}_{{θ}_{k}}\right) : = {E}_{\left(x , y\right) ∼ {D}_{k}} \text{KL} \left[{f}_{{ϕ}_{k}} \left(x\right) \left‖{h}_{{θ}_{k}} \left(x\right)\right)\right]$$

in which the KL-divergence KL is evaluated for the predictions of the proxy model parameters f_{Φk}(x) applied to the sampled training data x with respect to the predictions of the private model parameters h_{θk}(x) applied to sampled training data x.

The total loss L_{Φk} for the private model may then be given by Equation 3 as a combination of the respective losses of Equations 1 and 2:

$${L}_{{ϕ}_{k}} : = \left(1 - α\right) ⋅ {L}_{\text{CE}} \left({f}_{{ϕ}_{k}}\right) + α ⋅ {L}_{\text{KL}} \left({f}_{{ϕ}_{k}} ; {h}_{{θ}_{k}}\right)$$

In Equation 3, a is a weighted contribution between the private loss and distillation loss for the private model parameters.

The total loss L_{θk} for the proxy model in one embodiment includes similar components, including a cross-entropy loss L_{CE}(h_{θk}) with respect to the training batch and a KL-divergence loss L_{KL(}h_{θk}; f_{Φk}) with respect to the predictions of the private model:

$${L}_{{θ}_{k}} : = \left(1 - β\right) ⋅ {L}_{\text{CE}} \left({h}_{{θ}_{k}}\right) + β ⋅ {L}_{\text{KL}} \left({h}_{{θ}_{k}} ; {f}_{{ϕ}_{k}}\right)$$

In Equation 4, β is a weighted contribution between the private loss and distillation loss for the proxy model parameters, and in some embodiments may differ from the value of a for the private model.

When training the proxy model 210A, the proxy model may be trained with a differentially private algorithm, such that the contribution of individual data instances to the parameters of the proxy model 210A (i.e., the gradients for modifying the proxy model) are obscured and may be quantifiable. Differentially private algorithms may measure the effect of individual data instances by comparing the different probability outcomes Pr for probabilistic function M applied to the data set D (e.g., the training data) with the outcomes for M applied to a set D′ that includes or excludes a particular data instance compared to D. The probability outcome difference may be evaluated for all subsets of possible outputs S, allowing a measurement of the maximum contribution of a private data instance to the output of a probabilistic function M (e.g., the proxy model parameter training algorithm). The difference in probabilities of Smay be measured to determine a privacy cost as values ∈ and δ when applying algorithm M to the respective data sets D and D′ as shown in Equation 5:

$$Pr \left[M \left(D\right) ∈ S \left|\leq exp \left(∈\right) Pr \left[M \left({D}^{′}\right) ∈ S\right]\right) + δ\right)$$

The proxy model may thus use a differentially private algorithm that may be evaluated to determine the privacy cost, e.g., according to Equation 5. During training, the participant may monitor the privacy cost (e.g., as accumulated across multiple iterations), compare the privacy cost with a threshold, and determine to stop sharing the proxy model 210A with other participants when the threshold is reached or exceeded.

As such, gradients for updating parameters of the proxy model 210A may be generated with a differentially private algorithm and in one embodiment may be a differentially-private stochastic gradient descent (DP-SGD) algorithm. In one embodiment, the private model 220 is updated with gradients without differential privacy, while the proxy model 210 is updated with differentially private gradients. In some embodiments, the training gradients may be alternatively applied to each model. In one embodiment, gradients for the proxy model and private model for a given iteration i include stochastic gradient descent steps. Stochastic gradient descent for iteration i (having batch Bₖ =

$${B}_{k} = {\left\{\left({x}_{i} , {y}_{i}\right)\right\}}_{i = 1}^{B}$$

sampled from private data Dₖ) may be described for the private model parameters Φₖ as providing gradients ∇L̅_{Φk} for the batch as:

$$∇ {\hat{L}}_{{ϕ}_{k}} \left({B}_{k}\right) : \frac{1}{B} {\sum }_{i = 1}^{B} {\text{g}}_{{ϕ}_{k}}^{\left(i\right)}$$

in which the contribution of each training item in the batch may be given by:

$${\text{g}}_{ϕ k}^{\left(i\right)} : = \left(1 - α\right) {∇}_{{ϕ}_{k}} \text{CE} \left[{f}_{{ϕ}_{k}} \left({x}_{i}\right) \left|\left|{y}_{i}\right)\right)\right] + α {∇}_{{ϕ}_{k}} \text{KL} \left[{f}_{{ϕ}_{k}} \left(x\right) \left‖{h}_{{θ}_{k}}\right) \left({x}_{i}\right)\right]$$

To provide differential privacy for training the proxy model 210A, the initial gradients for the contribution and stochastic loss may be similarly defined as ∇L̅_{θk} (Bk) and

$${\text{g}}_{{θ}_{k}}^{\left(i\right)} ,$$

such that the gradients per item of

$${\text{g}}_{{θ}_{k}}^{\left(i\right)}$$

may be evaluated with respect to the proxy model parameters and the KL-divergence may be evaluated relative to the predictions of the private model with a weight β. The per-item gradient may be modified to clip the gradients (i.e., limit the contribution of the gradients to a maximum value) as shown in Equation 7:

$${\overline{\text{g}}}_{{θ}_{k}}^{\left(i\right)} : = {\text{g}}_{{θ}_{k}}^{\left(i\right)} / max \left(1 , {\left‖{\overline{\text{g}}}_{θ k}^{\left(i\right)}\right‖}_{2} \text{/C}\right)$$

The clipped gradients may then be averaged and combined with Gaussian Noise given by samples from a Gaussian distribution N(0, σ²C²I):

$$\tilde{∇} {\hat{L}}_{{θ}_{k}} \left({B}_{k}\right) : = \frac{1}{B} \left({\sum }_{i = 1}^{B} {\overline{\text{g}}}_{{ϕ}_{k}}^{\left(i\right)} + N \left(0 , {σ}^{2} {C}^{2} I\right)\right)$$

In Equations 7 and 8, C is the clipping threshold, σ is a noise level(that may affect the strength of privacy provided by the sampling), and I is the identity matrix. By clipping the contribution of each item, averaging the results, and adding noise, the contribution of an individual item cannot exceed the clipped value and is further obscured by the averaging and noise addition, such that individual item contributions may be bounded and computable as a differential privacy cost that permits participants to measure the privacy cost of sharing the proxy model 210A and, when necessary, to stop participating when the privacy cost exceeds a threshold (i.e., a budget). The gradients for the respective models may then be applied to the models to update the model parameters.

The proxy model 210A may thus have a different architecture than the private model 220 because the training process may use the output predictions of the respective models, rather than the particular architecture or parameter values. This enables the private model to have a different architecture from the proxy model 210A and from other private models 220 that may be used by other model training systems 200B, 200C. Similarly, the proxy model 210A has fewer parameters in some embodiments (e.g., a smaller architecture), enabling the proxy model 210A parameters to be more easily shared with other participants and reducing the extent to which the parameters of the proxy model reveal information about private data of the participant. By training the proxy (but not the private model) with a differentially private algorithm, participants may measure the extent to which private information may be revealed as a privacy cost while benefiting from an effective private model that benefits from proxy model information. In addition to the training discussed with respect to parameters of the proxy model 210A and private model 220, the proxy model 210A may be mixed with (e.g., exchanged with) the proxy models of other participants, e.g., to receive proxy models 210B, C. After training, the private model 220 may then be used for inference of new private data instances 240.

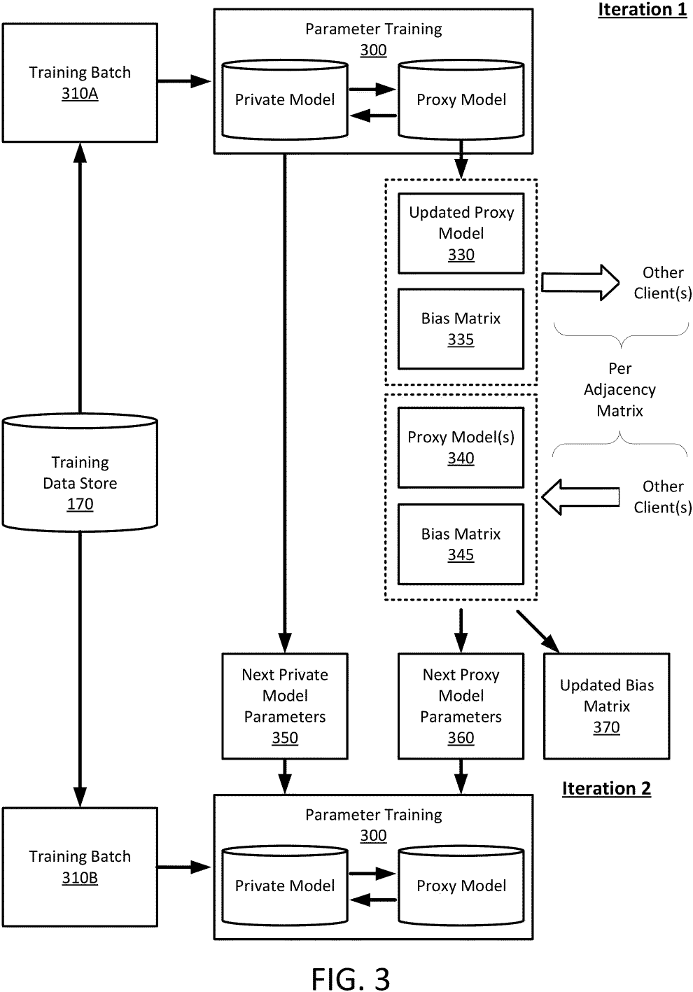

FIG. 3 shows an example of a training iteration for training parameters of a participant’s private model and proxy model, according to one embodiment. The example of FIG. 3 is one embodiment for training these models; additional approaches may also be used for training the private and proxy models in additional embodiments. In this embodiment, each training iteration includes training parameters of the private model and proxy model and mixing the proxy model parameters with parameters of other proxy models from other participants (e.g., trained at other model training systems with other private data).

To begin an iteration, a set of training data is selected (e.g., sampled) from the set of training data stored in the training data store 170 as a training batch 310 for the iteration, shown as training batch 310A for iteration 1 and training batch 310B for iteration 2 of FIG. 3. Parameters of the private model and proxy model may be updated with parameter training 300 as discussed above, which may include losses with respect to the training batch 310 and with respect to the parameters of the other model. In this embodiment, the updated parameters of the private model may then be set as a set of next private model parameters 350 for the next iteration of parameter training 300. The parameter training 300 may generate an updated proxy model 330.

The proxy model may be mixed with the proxy models of other participants between iterations of parameter training 300. The proxy model may be mixed with other participants in a variety of different ways in different configurations. In some circumstances, the proxy models may be mixed with a centralized system that combines the proxy models from all participants and returns a set of next proxy model parameters 360 to be used in the next iteration.

In another embodiment, as shown in FIG. 3, the proxy models may be shared according to an adjacency matrix. The adjacency matrix may indicate, for a given iteration, which proxy models are shared with which other participants, such that the proxy model parameters may be mixed peer-to-peer with other model training systems. The adjacency matrix may thus represent a directed graph between the participants, and may not be bi-directional (e.g., a given participant may send its proxy model to another participant and may not receive that other participant’s proxy model in return). The adjacency matrix for a given iteration t may thus be indicated as adjacency matrix P^{(t)} ∈ ℝ^{|k|×|k|}, such that

$${P}_{k , {k}^{′}}^{\left(t\right)} \neq 0$$

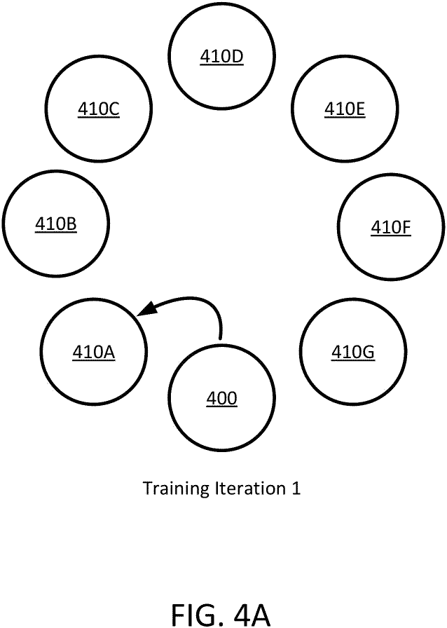

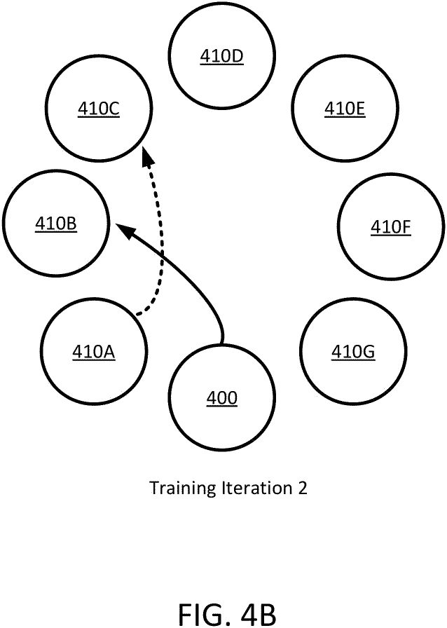

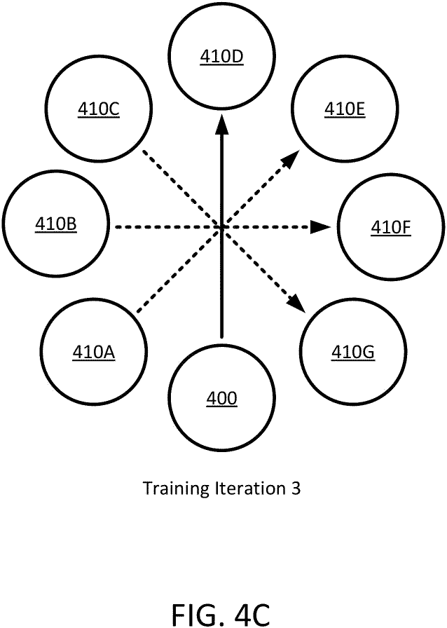

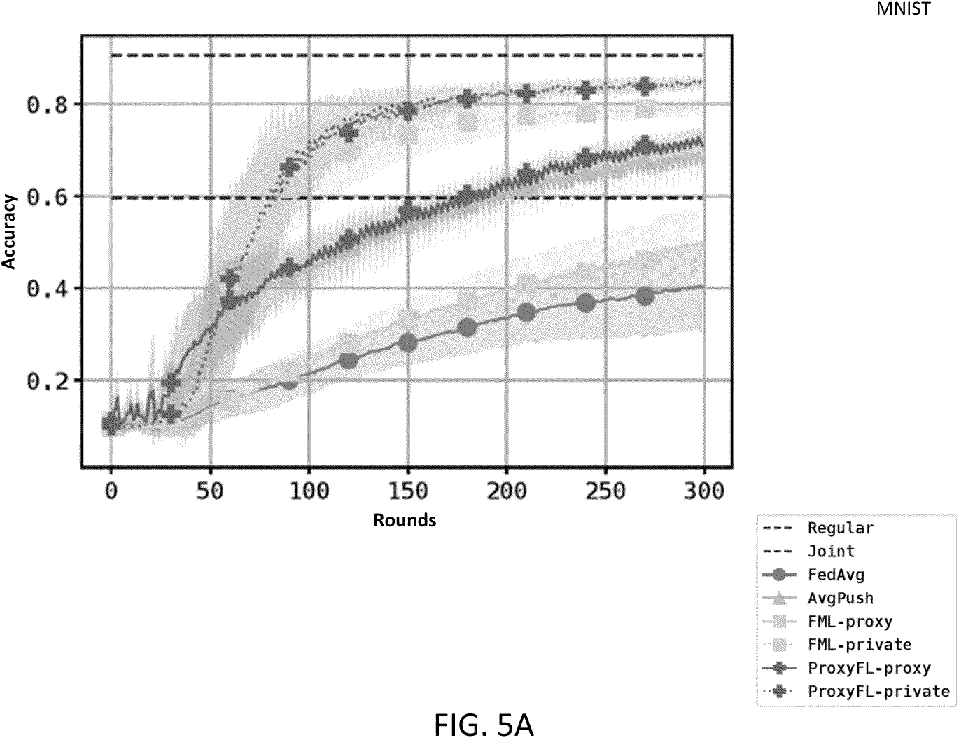

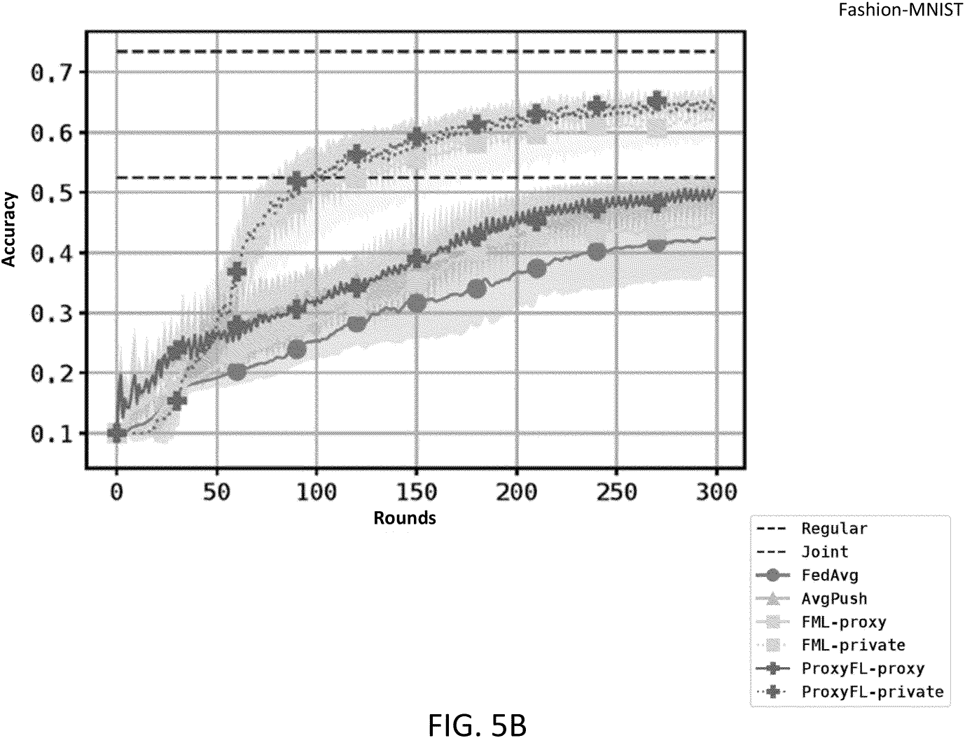

indicates that participant (e.g., client) k receives the proxy from participant k′. The adjacency matrix may be modified in each iteration according to a communication protocol that may vary in different embodiments. FIGS. 4A-C, discussed below, shows one embodiment in which the communication protocol is an exponential communication protocol.

In some configurations, combining proxy model parameters from different participants may also introduce a bias to the model parameters that may be corrected based on a bias matrix 335. The bias matrix 335 may represent the contribution of respective participants to the current proxy model of a participant and used to correct the bias that may be introduced. The weights for the bias matrix w for participant k at iteration t may also be designated

$${w}_{k}^{\left(t\right)} .$$

In these embodiments, the updated proxy model 330 along with the client’s current bias matrix 335 may be sent to other clients (e.g., participants’ model training systems) according to the adjacency matrix P(t), and the respective proxy models 340 and bias matrix 345 received from other clients.

In this embodiment, the next proxy model parameters 360 may be determined by combining the received proxy models 340 and determining an updated bias matrix 370 for the next iteration. In one embodiment, the next proxy model parameters 360 are determined based on the received proxy models 340 and replace the updated proxy model 330. That is, in this embodiment the local participant’s proxy parameters are not used in determining the next iteration’s proxy parameters

$${θ}_{k}^{\left(t + 1\right)}$$

(i.e., next proxy model parameters 360). To do so, in one embodiment, the next proxy model parameters

$${θ}_{k}^{\left(t + 1\right)}$$

may be determined based on the adjacency matrix

$${P}_{k , {k}^{′}}^{\left(t\right)}$$

for the iteration t applied as weights to the received proxy model parameters

$${θ}_{{k}^{′}}^{\left(t\right)}$$

, from other participants k′ as given by:

$${θ}_{k}^{\left(t + 1\right)} = {P}_{k , {k}^{′}}^{\left(t\right)} {θ}_{{k}^{′}}^{\left(t\right)} .$$

The updated bias matrix 370 (also designated

$$\left({w}_{k}^{\left(t + 1\right)}\right)$$

may be determined by combining the received bias matrices 345

$$\left({w}_{{k}_{′}}^{\left(t\right)}\right)$$

according to the adjacency matrix:

$${w}_{k}^{\left(t + 1\right)} = \sum {}_{k} {P}_{k , {k}^{′}}^{\left(t\right)} {w}_{k}^{\left(t\right)} .$$

In this embodiment, the updated bias matrix adjusts the bias of the received proxy models according to the adjacency matrix describing the combination of proxy models at the current participant. Finally, the updated bias matrix may be applied to debias the proxy model parameters for the next iteration by dividing the parameters by the updated bias matrix 370:

$${θ}_{k}^{\left(t + 1\right)} = {θ}_{k}^{\left(t + 1\right)} / {w}_{k}^{\left(t + 1\right)} .$$

As such, in the embodiment of FIG. 3 where the proxy model is replaced by proxy models received from other clients, the private data may contribute to the proxy model in the parameter training 300 (which may account for the privacy cost as discussed above) that is then shared with other participants according to the adjacency matrix. By replacing the participant’s proxy model based on the received proxy models, the contribution of the proxy model in contributing to the cross-training of the private model (e.g., via the distillation loss) may promote contribution of the other participant’s data, rather than parameters learned from the local private data, which is already reflected in the parameters of the private model. Overall, this approach enables the private model to benefit from training based on other participants’ private data via the distillation loss from the proxy models while maintaining a focus on the local private data.

FIGS. 4A-C show an exponential communication protocol, according to one embodiment. In this example, the participants are ordered (e.g., numbered 0-k), such that each participant may communicate with another participant that is 2ⁿ steps away in the order, where n is the current number of training iterations. In this example, each participant may share its proxy model with a single participant, such that the proxy model for participant i of total participants k may be shared with participant (i + 2ⁿ) mod k. FIGS. 4A-C show the communication for participant 400 with respect to other participants 410A-G. In the first training iteration, shown in FIG. 4A, participant 400 sends its proxy model to participant 410A. In the next training iteration, shown in FIG. 4B, the participant 400 sends its proxy model to participant 410B, while participant 410A sends its proxy model to participant 410C. As such, a contribution by participant 400 was provided to participant 410A in the first round, and while participant 400 provides a contribution to participant 410B directly in the second round, a contribution is indirectly provided from participant 400 to participant 410C by participant 410A. Finally, in FIG. 4C, participant 400 directly sends its proxy model to participant 410D. As with FIG. 4B, a contribution of participant 400 may be reflected in proxy parameters distributed by participants 410A-C to respective participants 410E-G. As such, while the exponential communication protocol in this example may send the proxy parameters peer-peer to one other participant, each participant’s contribution may affect many subsequent participants and effectively spread proxy model parameter information throughout the participating clients.

### Experimental Results

Experiments were performed on one embodiment of the invention following the training processes and proxy model mixing as discussed with respect to FIGS. 2-4. This embodiment, termed ProxyFL, includes the distillation loss for the models, differentially private stochastic gradient descent (DP-SGD) parameter updates, and exponential communication method discussed above.

A first experiment was performed to compare the accuracy of the ProxyFL embodiment with other federated models. Experiments were conducted with popular datasets including MNIST, Fashion-MNIST (“FaMNIST” or “Fa/MNIST”), and CIFAR-10, in which the data sets were split to 8 participants and weighted with respect to class distribution to mimic the different data set compositions that may be available for different participants in practical applications.

Fa/MNIST has 60k training images of size 28×28, while CIFAR-10 has 50k RGB training images of size 32×32. Each dataset has 10k test images, which are used to evaluate the model performance. Experiments were conducted on a server with 8 V100 GPUs, which correspond to 8 clients. In each run, every client had 1k (Fa/MNIST) or 3k (CIFAR-10) nonoverlapping private images sampled from the training set. To test robustness on non-IID data (i.e., data with a different distribution than the client’s private training data), clients were given a skewed private data distribution. For each client, a randomly chosen class was assigned and a fraction pmajor (0.8 for Fa/MNIST; 0.3 for CIFAR-10) of that client’s private data was drawn from that class. The remaining data was randomly drawn from all other classes in an IID manner. Hence, clients must learn from collaborators to generalize well on the IID test set.

ProxyFL was evaluated with respect to various models including FedAvg, Federated MutualLearning (FML), AvgPush, Regular, and Joint training. FedAvg and FML are centralized schemes that average models with identical structure. FML is similar to ProxyFL in that every client has two models, except FML does centralized averaging. AvgPush is a decentralized version of FedAvg that uses a “PushSum” scheme for model parameter aggregation. Regular training uses the local private datasets without any collaboration. Joint training mimics a scenario without constraints on data centralization by combining data from all clients and training a single model. Regular, Joint, FedAvg, and AvgPush were trained with DP-SGD for training their models, while ProxyFL and FML use it for their proxies in these experiments.

The model architectures used in these experiments for the private/proxy models are LeNet5/MLP for Fa/MNIST, and CNN2/CNN1 for CIFAR10. All methods use the Adam optimizer (Kingma and Ba 2014) with learning rate of 0.001, weight decay of 1e-4, mini-batch size of 250, clipping threshold C = 1.0 and noise level σ = 1.0. Each round of local training takes a number of gradient steps equivalent to one epoch over the private data. For proper DP accounting, minibatches were sampled from the training set independently with replacement by including each training example with a fixed probability. The mutual learning parameter (e.g., a and β of Equations 3 and 4 above) is set at 0.5 for FML and ProxyFL.

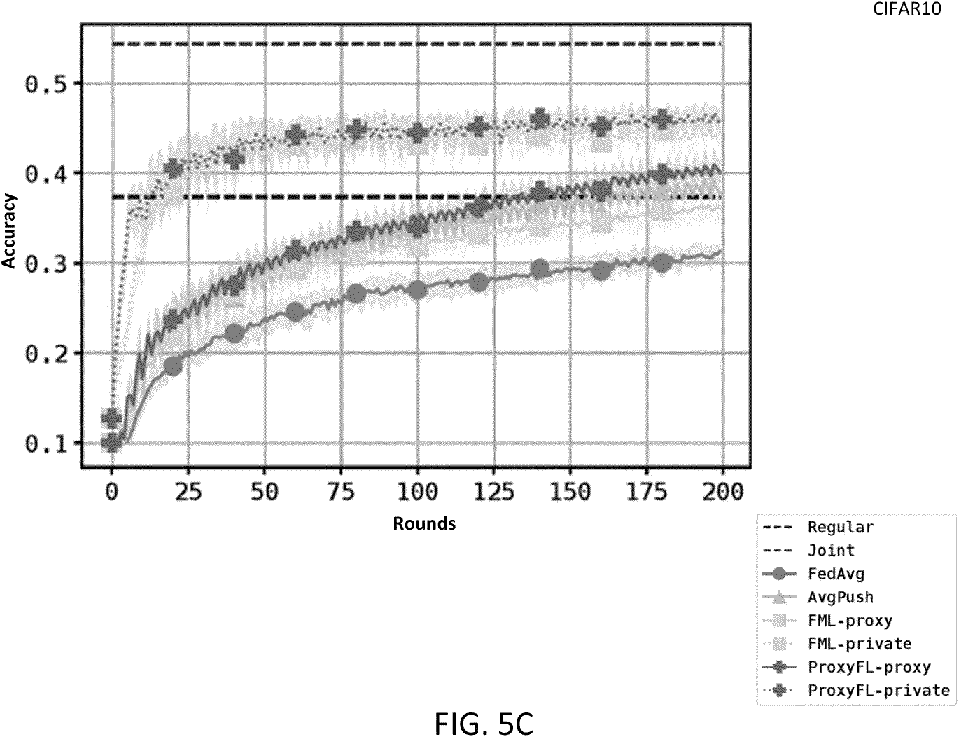

FIGS. 5A-C shows the performance on the test datasets of one embodiment. This chart illustrates that ProxyFL’s private models outperformed all other federated learning approaches. The private models of ProxyFL achieve the best overall performance on all datasets, even better than the centralized counterpart FML. Note that the Joint method serves as an upper bound of the problem when private datasets are combined.

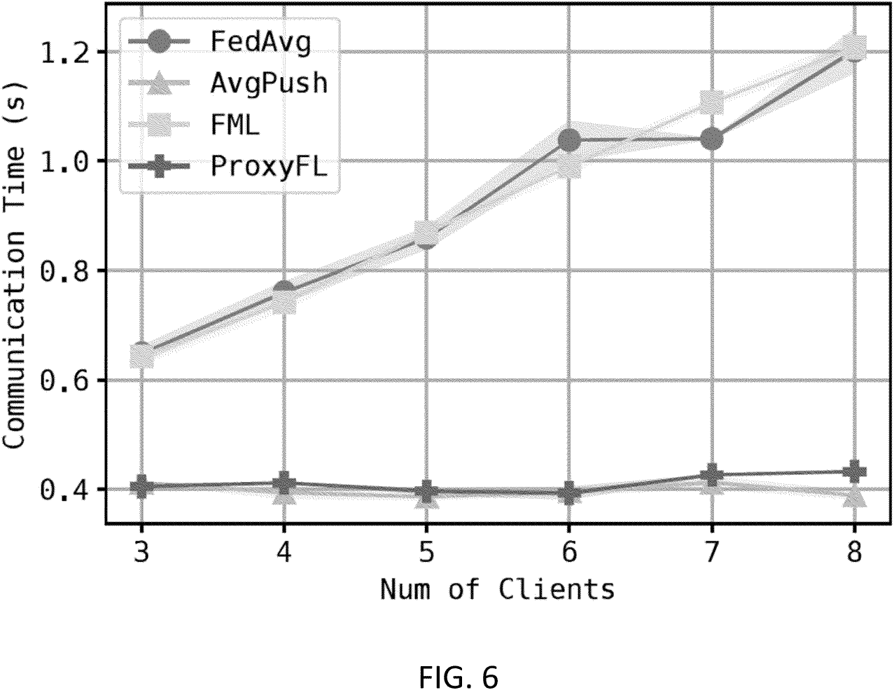

FIG. 6 shows the communication time for exchanging parameters for one embodiment in experiments. ProxyFL has a much lower communication cost compared to FML, as shown in FIG. 6. The exponential protocol has a constant time complexity per round regardless of the number of clients, which makes ProxyFL much more scalable.

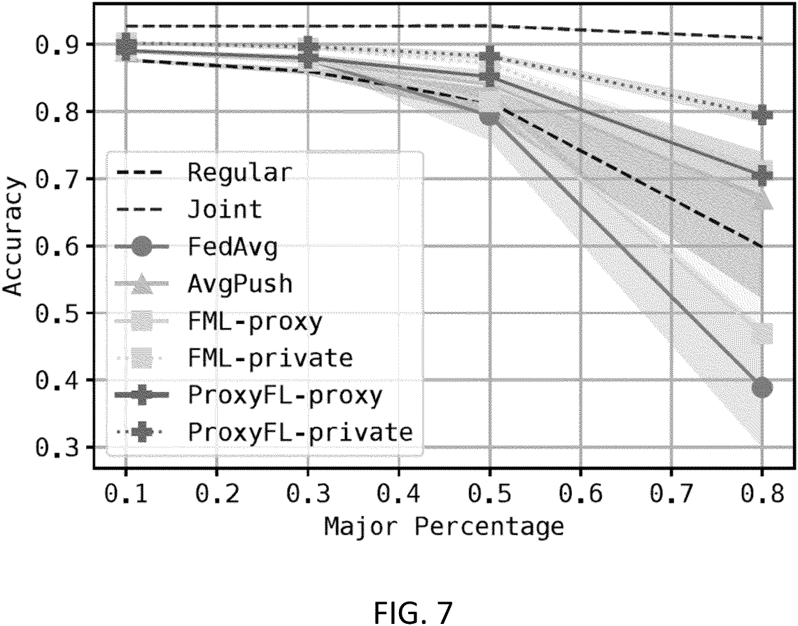

FIG. 7 shows the performance of experiments with an embodiment on data with different levels of non-IID dataset skew. As the setting deviates from the in-distribution private data, represented by the . 1 major percentage, most methods degrade except for Joint training since it unifies the datasets. The private model of ProxyFL is the most robust to the degree of non-IID dataset skew. Note that the proxy model of ProxyFL achieves similar performance to the private model of FML, which is trained without differential privacy. This indicates that ProxyFL is robust to distribution shifts among the clients while being able to provide privacy guarantees with DP training.

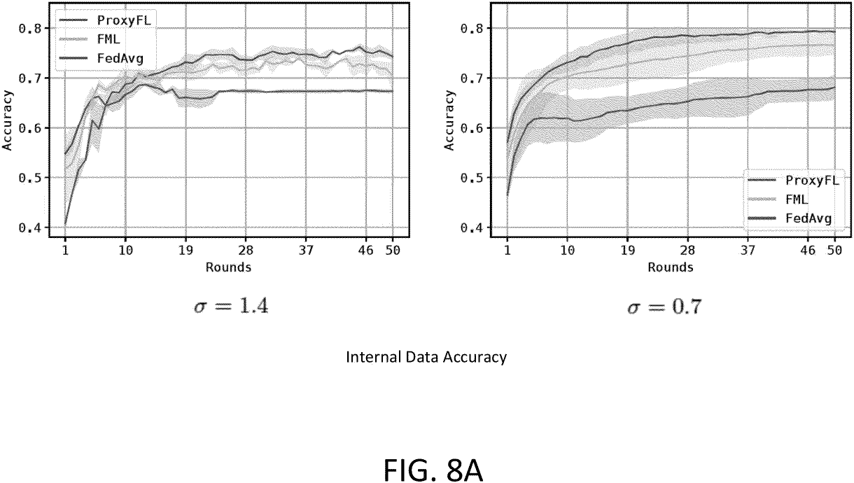

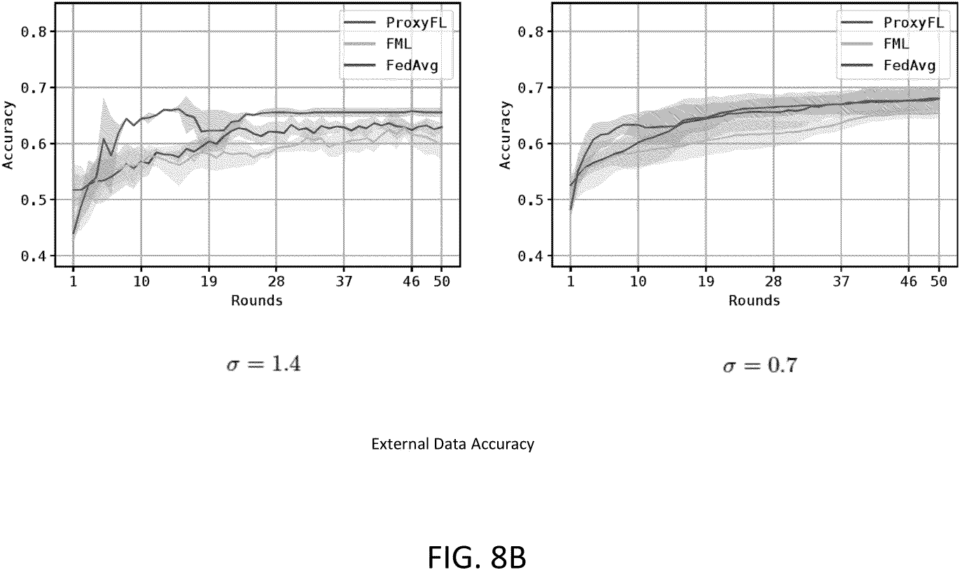

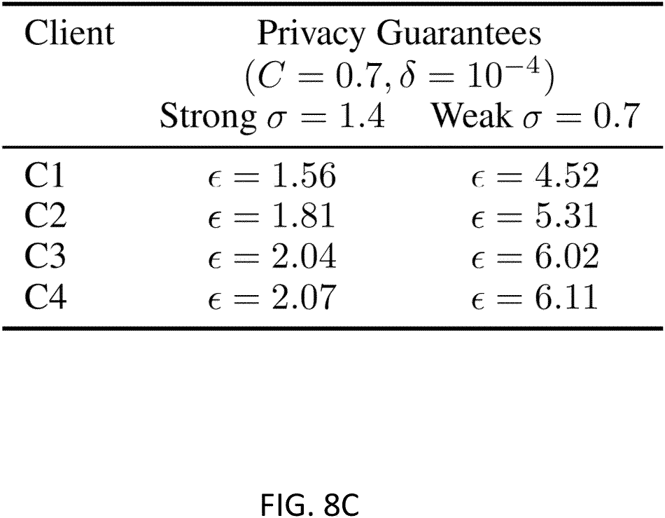

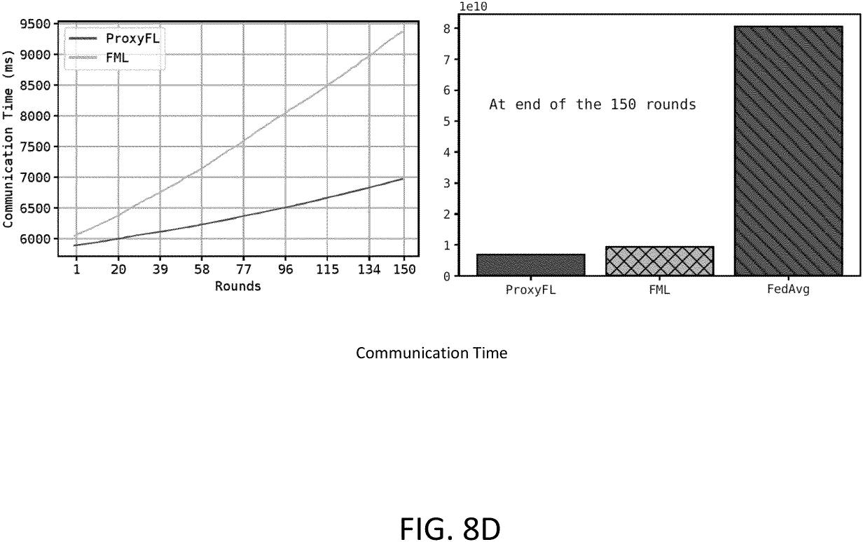

FIGS. 8A-D show example results for an experiment, according to one embodiment. In this embodiment, ProxyFL was applied to a multi-origin real-world dataset: the largest public archive of whole-slide images (WSIs), namely The Cancer Genome Atlas (TCGA). TCGA provides about 30,000 H&E stained WSIs originating from various institutions, distributed across multiple primary diagnoses. The client data for this study was derived from TCGA by splitting it across four major institutions: i) University of Pittsburgh, ii) Indivumed, iii) Asterand, and iv) Memorial Sloan Kettering Cancer Center (MSKCC).

Each WSI is an extremely large image (more than 50,000 × 50,000 pixels with a size often much larger than several hundred MBs), and typically is not effectively processed directly by computer models such as a convolutional neural network (CNN). In order to classify a WSI, it is divided into a small number of representative patches called a mosaic. The mosaic patches were then converted into feature vectors using a pre-trained DenseNet. Each WSI corresponds to a set of features; these sets are then used for training a classifier based on the DeepSet architecture. In the context of ProxyFL, both the private and proxy models are DeepSet-based.

The experiments on WSI data were conducted using four V100 GPUs. Three FL methods were compared: ProxyFL, FML, and FedAvg. In each scenario, training was conducted for 50 rounds with a mini-batch size of 16. All methods were tested with two DP settings, one with strong privacy σ = 1.4, and the other with comparatively weak privacy σ = 0.7, both with C = 0.7. The client-level privacy guarantees for the two DP settings are provided in FIG. 8C. FedAvg and the proxy models used the DP-SGD optimizer, whereas the private models used the Adam optimizer, both with a learning rate of 0.001. For ProxyFL and FML the private models are used to compute the accuracy values, whereas the central model is used in the case of FedAvg.

Performance was computed based on two test datasets-internal and external. Both datasets are local to the clients. Internal test data is sampled from the same distribution as the client’s private training data, whereas external test data comes from other clients involved in the federated training, and hence a different institution entirely. The 32 unique primary diagnoses in the dataset can be further grouped into 13 tumor types. The tumor type of a WSI is generally known at inference time, so the objective is to predict the cancer subtype. We evaluated our method by its accuracy of classifying a cancer sub-type (primary diagnosis) of a WSI given that its tumor type is already known.

The sub-type classification results for internal and external data on two different DP settings (strong and weak privacy) for each method are shows in FIGS. 8A-B. FIG. 8A shows internal data accuracy and FIG. 8B shows external data accuracy. ProxyFL achieves, overall, higher accuracy compared to FML and FedAvg on the internal test data for both privacy settings. For the external test data, all three methods perform similar to each other with FedAvg slightly ahead when using stronger privacy guarantees. ProxyFL has noticeably better convergence compared to FML as shown by the lower variance in both the privacy settings. When strong privacy is used, the FedAvg central model has converged by around the 25ₜₕ round showing no improvement in the performance across both test datasets. As shown in FIG. 8D, both ProxyFL and FML are more communication efficient than FedAvg because they exchange lightweight models during rounds as opposed to larger private models. ProxyFL has the lowest communication overhead due to using fewer model exchanges.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for shared model training with private data protection, comprising:
a processor; and
a computer-readable medium having instructions executable by the processor for:
identifying a set of proxy parameters for a proxy model and a set of private parameters for a private model;
training the proxy parameters and private parameters for a training iteration by:
identifying a training batch from a private training data set;
determining a set of proxy predictions from the proxy model applied to the training batch with the set of proxy parameters;
determining a set of private predictions from the private model applied to the training batch with the set of private parameters;
training the proxy parameters to reduce a proxy loss based the set of proxy predictions evaluated with respect to labels for the training batch and the set of private predictions;
training the private parameters to reduce a private loss based on the set of private predictions evaluated with respect to labels for the training batch and the set of proxy predictions; and
mixing the proxy parameters with one or more sets of other proxy model parameters trained with different private data.

2. The system of claim 1, wherein mixing the proxy parameters, including replacing the proxy parameters with proxy parameters based on the one or more other proxy model parameters.

3. The system of claim 1, wherein mixing the proxy parameters includes sending the proxy parameters and a bias matrix to another system training another proxy model.

4. The system of claim 1, wherein mixing the proxy parameters includes receiving a bias matrix for each set of other proxy model parameters and applying the received bias matrix to debias the proxy parameters.

5. The system of claim 1, wherein mixing the proxy model parameters with the one or more other proxy model parameters is based on an adjacency matrix.

6. The system of claim 5, wherein the adjacency matrix is modified in different training iterations.

7. The system of claim 6, wherein the adjacency matrix is determined for the training iteration by an exponential communication protocol.

8. The system of claim 1, wherein the proxy model is trained with a differentially private algorithm.

9. The system of claim 8, wherein the differentially private algorithm measures a privacy cost of training the proxy model.

10. The system of claim 9, wherein the privacy cost is measured for a plurality of training iterations and the model training ends when a total privacy cost reaches a threshold.

11. The system of claim 1, wherein the proxy model and private model have different model architectures.

12. A method for shared model training with private data protection, comprising:
identifying a set of proxy parameters for a proxy model and a set of private parameters for a private model;
training the proxy parameters and private parameters for a training iteration by:
identifying a training batch from a private training data set;
determining a set of proxy predictions from the proxy model applied to the training batch with the set of proxy parameters;
determining a set of private predictions from the private model applied to the training batch with the set of private parameters;
training the proxy parameters to reduce a proxy loss based the set of proxy predictions evaluated with respect to labels for the training batch and the set of private predictions;
training the private parameters to reduce a private loss based on the set of private predictions evaluated with respect to labels for the training batch and the set of proxy predictions; and
mixing the proxy parameters with one or more sets of other proxy model parameters trained with different private data.

13. The method of claim 12, wherein mixing the proxy parameters includes replacing the proxy parameters with proxy parameters based on the one or more other proxy model parameters.

14. The method of claim 12, wherein mixing the proxy parameters includes sending the proxy parameters and a bias matrix to another system training another proxy model.

15. The method of claim 12, wherein mixing the proxy parameters includes receiving a bias matrix for each set of other proxy model parameters and applying the received bias matrix to debias the proxy parameters.

16. The method of claim 12, wherein mixing the proxy model parameters with the one or more other proxy model parameters is based on an adjacency matrix.

17. The method of claim 16, wherein the adjacency matrix is modified in different training iterations.

18. The method of claim 17, wherein the adjacency matrix is determined for the training iteration by an exponential communication protocol.

19. The method of claim 12, wherein the proxy model is trained with a differentially private algorithm.

20. The method of claim 19, wherein the differentially private algorithm measures a privacy cost of training the proxy model.
